(19) United States
(12) Patent Application Publication
(10) Pub. No.: US 2024/0100601 A1
(43) Pub. Date: Mar. 28, 2024

(54) IMPROVED VESSEL FOR ATTENUATING DROSS IN MELTED METAL IN A METAL DROP EJECTING THREE-DIMENSIONAL (3D) OBJECT PRINTER

(71) Applicant: ADDITIVE TECHNOLOGIES LLC, PALM CITY, FL (US)

(72) Inventors: Douglas K. Herrmann, Webster, NY (US); Varun Sambhy, Pittsford, NY (US); Jason M. LeFevre, Penfield, NY (US); Seemit Praharaj, Webster, NY (US)

(21) Appl. No.: 17/935,691

(22) Filed: Sep. 27, 2022

(51) Int. Cl. B22F 12/53; B22D 23/00; B22F 10/85; B22F 12/90; B33Y 30/00; B33Y 50/02

(52) U.S. Cl. CPC B22F 12/53; B22D 23/003; B22F 10/85; B22F 12/90; B33Y 30/00; B33Y 50/02; B22F 2202/05

(57) ABSTRACT

A three-dimensional (3D) metal object manufacturing apparatus is equipped with a vessel having a receptacle that holds melted metal. The vessel has one or more electrical coils positioned at an upper end of the vessel near an inlet for solid metal that is melted within the receptacle. AC electrical current is passed through the one or more electrical coils to produce traveling magnetic fields in the melted metal at the upper end of the receptacle in the vessel to stir the melted metal and attenuate the formation of dross in the melted metal.

### TECHNICAL FIELD

This disclosure is directed to three-dimensional (3D) object printers that eject melted metal drops to form objects and, more particularly, to the vessel in which the metal is melted and stored before ejection in such printers.

### BACKGROUND

Three-dimensional (3D) printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Additive manufacturing methods are distinguishable from traditional object-forming techniques, which mostly rely on the removal of material from a work piece by a subtractive process, such as cutting or drilling.

Some 3D object printers eject drops of melted metal from one or more ejectors to form 3D objects. These printers have a source of solid metal, such as a roll of wire or pellets, that is fed into an inlet of a heated receptacle of a vessel in an ejector of the printer where the solid metal is melted and the melted metal fills the receptacle. As used in this document, the term “vessel” means a container configured with a volumetric cavity within the container and the term “receptacle” means the volumetric cavity within a vessel that is configured to hold melted metal and the cavity is in fluid communication with an opening in the vessel through which drops of melted metal are ejected from the cavity. The opening in the vessel through which the melted metal drops are ejected is called a nozzle. The vessel is made of non-electrically conductive material around which an electrical wire is wrapped in the vicinity of the nozzle to form a coil. An electrical current is passed through the coil to produce an electromagnetic field that causes the meniscus of the melted metal at the nozzle of the vessel to separate from the melted metal within the receptacle and be propelled from the nozzle. A platform opposite the nozzle of the vessel in the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. This type of metal drop ejecting printer is also known as a magnetohydrodynamic (MHD) printer.

The melted metal in the receptacle of the vessel in the printer needs to be maintained at a level sufficient to support metal drop ejection operations without exhausting the supply of melted metal in the printer. In one metal drop ejecting printer a blue laser is directed to a surface level of the melted metal within the receptacle and a sensor monitors the reflection of the laser by the surface level to determine the current height of the melted metal in the receptacle. When the sensor output indicates the level of the surface has dropped to a threshold position within the receptacle, a wire-feeding actuator is operated to feed more solid metal into the receptacle for melting and to fill the receptacle to a predetermined level.

During the printing process performed by a MHD printer, the metal, which is typically aluminum and metal alloys, such as magnesium, form oxides as the metal is melted at the inlet to the vessel. These oxides are commonly referred to as “dross.” As used in this document, the term “dross” means a combination of materials in the vessel of a MHD printer that is unsuitable for object formation. These materials include aluminum oxide, magnesium oxide, aluminum trapped by these oxides, and gas bubbles formed during melting of the solid metal. This dross builds up in the vessel during the printing process and the amount of dross produced corresponds to the amount of metal melted in the vessel. Dross builds at the top of the melted metal in the receptacle of the vessel and causes issues during printing.

One issue arising from the production of dross is the adverse impact of dross on the ability of the laser level-sensor to measure the distance between the laser level-sensor and the upper surface of the molten metal level in the receptacle of the vessel. The dross is dark and has a rough surface that affects the reflection of the laser and its reception by the sensor. If the level is not accurately monitored, the vessel can empty during the printing process and ruin the metal object. All dross related level-sensing failures lead to a premature shutdown of the printer, removal of the dross, replacement of the vessel nozzle, and restarting of the printer. Because the printer must be shutdown to remove the dross, its time of operation is limited. This time of operation limitation means the amount of metal ejected is also limited so the number and size of the objects produced is sub-optimal. Additionally, the temperature of the melted metal cannot reach the temperatures optimal for metal drop ejection since the higher melted metal temperatures produce more dross. Finding a way to keep the dross from affecting the melted metal level sensing and extending the time for printer production would be beneficial.

### SUMMARY

A new vessel for a 3D metal object printer stirs the melted metal in the receptacle of the vessel to attenuate the production of dross on the surface of the melted metal in the receptacle so the melted metal level in the receptacle can be measured by the laser level-sensor. The new vessel includes a wall defining a receptacle within the vessel, the receptacle having an inlet at a first end of the vessel and a nozzle at a second end of the vessel; a heater configured to heat the vessel so melted metal within the receptacle remains molten; and at least one electrical coil wrapped around a portion of the vessel at a position closer to the inlet of the receptacle than to the nozzle of the receptacle, the at least one electrical coil being configured to produce at least one traveling magnetic field within the melted metal in the receptacle near the inlet.

A new 3D metal object printer includes a vessel that stirs the melted metal in the receptacle of the vessel to attenuate the production of dross on the surface of the melted metal in the receptacle so the melted metal level in the receptacle can be measured by the laser level-sensor. The new 3D metal object printer includes an ejector head having a vessel that defines a receptacle and a heater configured to heat the vessel so melted metal within the receptacle remains molten, the vessel having a first end and a second end and the receptacle having an inlet at the first end of the vessel and the receptacle having a nozzle at the second end of the vessel; and at least one electrical coil wrapped around a portion of the vessel at a position closer to the inlet of the receptacle than to the nozzle of the receptacle, the at least one electrical coil being configured to produce at least one traveling magnetic field within the melted metal in the receptacle near the inlet.

### BRIEF DESCRIPTION OF THE DRAWINGS

The foregoing aspects and other features of a vessel for a 3D metal object printer that stirs the melted metal in the receptacle of the vessel to attenuate the production of dross on the surface of the melted metal in the receptacle so the melted metal level in the receptacle can be measured by the laser level-sensor are explained in the following description, taken in connection with the accompanying drawings.

FIG. 1 is a cross-sectional view of a new 3D metal object printer having a vessel that stirs the melted metal in the receptacle of the vessel to attenuate the production of dross on the surface of the melted metal in the receptacle so the melted metal level in the receptacle can be measured by the laser level-sensor.

FIG. 2 is an enlarged view of the cross-sectional portion of FIG. 1 that shows the ejector 140 with the coil 204 wrapped around the upper portion of the vessel 104 to stir the upper portion of the melted metal electromagnetically.

FIG. 3 is a perspective view of the vessel shown in FIG. 1 and FIG. 2.

FIG. 4 is a cross-sectional view of the vessel taken along line 4-4 in FIG. 3.

FIG. 5 is a perspective view of an alternative embodiment of the vessel shown in FIG. 3.

FIG. 6 is a cross-sectional view of the vessel of FIG. 5 taken along line 6-6 in

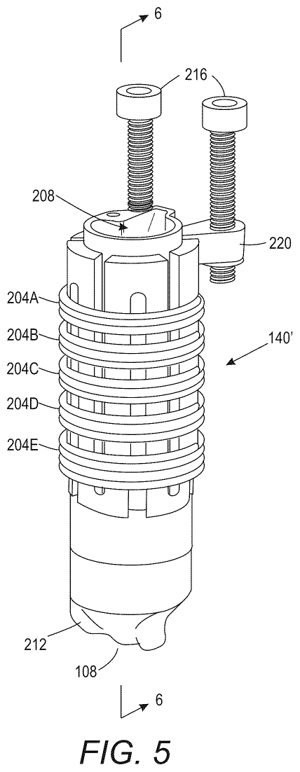

FIG. 5.

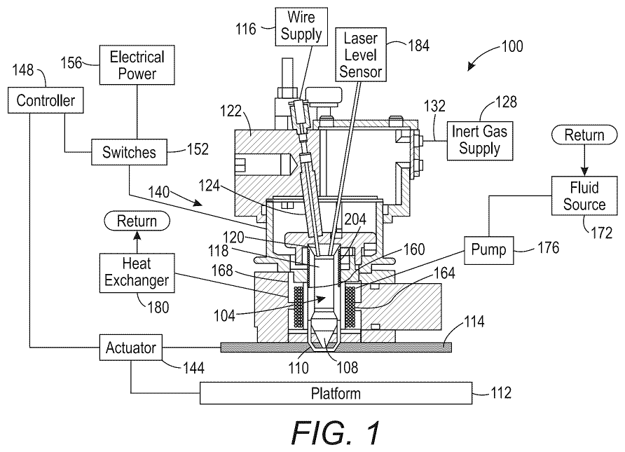

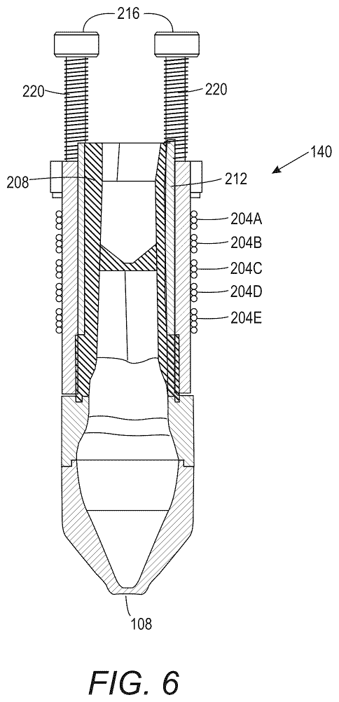

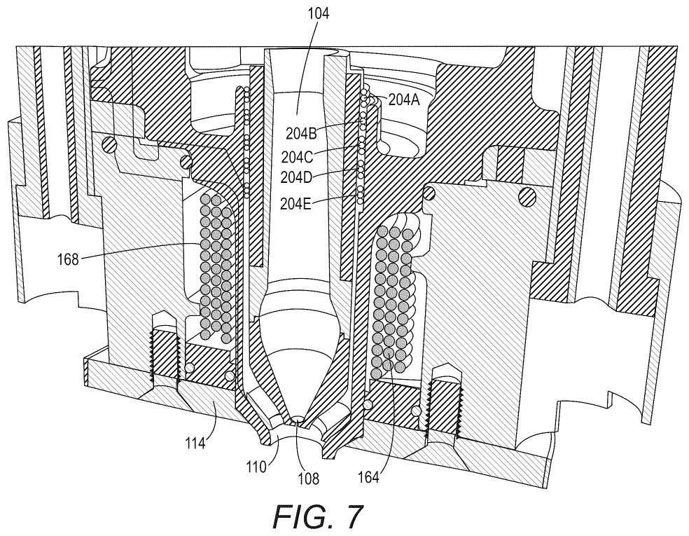

FIG. 7 is a cross-sectional view of the alternative embodiment of the vessel shown in FIG. 6 installed in the inkjet printer of FIG. 1.

### DETAILED DESCRIPTION

For a general understanding of the environment for the 3D metal object printer and its operation as disclosed herein as well as the details for the printer and its operation, reference is made to the drawings. In the drawings, like reference numerals designate like elements.

FIG. 1 illustrates an embodiment of a previously known 3D metal object printer 100 that stirs an upper portion of the melted metal in the receptacle where the melted metal is stored before ejection. This embodiment pulses an electrical current through an electrical coil 204 wrapped around the outside of the vessel 118 to produce Lorentz forces in the upper portion of the melted metal that stir the melted metal so formation of dross at the surface of the melted metal is attenuated. As used in this document, the term “electrical coil” means a length of electrical conductor wrapped around an object for multiple turns. In the printer of FIG. 1, drops of melted bulk metal are ejected from a receptacle of a removable vessel 104 having a single nozzle 108 and drops from the nozzle form swaths for layers of an object on a platform 112. As used in this document, the term “removable vessel” means a hollow container having a receptacle configured to hold a liquid or solid substance and the container as a whole is configured for installation and removal in a 3D metal object printer. As used in this document, the term “bulk metal” means conductive metal available in aggregate form, such as wire of a commonly available gauge or pellets of macro-sized proportions. A source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice in a removable vessel configured for the expulsion of melted metal drops from the receptacle within the removable vessel. As used in this document, the term “ejector head” means the housing and components of a 3D metal object printer that melt, eject, and regulate the ejection of melted metal drops for the production of metal objects. A laser level-sensor 184 includes a light source and a sensor. As used in this document, the term “level-sensor” means a device that generates a signal indicating the distance between the level-sensor and an upper surface of melted metal in the receptacle of a vessel and a signal indicating the intensity of the reflected light. In one embodiment, the light source of the level-sensor is a laser and, in some embodiments, a blue laser having a wavelength in a range of 400 nm to 500 nm. The reflection of the laser off the melted metal level is detected by the sensor, which generates a signal indicative of the distance to the melted metal level and a signal indicative of the intensity of the reflected light. The controller receives this signal and when the controller determines the distance is at a predetermined threshold distance that corresponds to a resupply level, the controller operates an actuator to resupply solid metal to the inlet of the receptacle and maintain the surface of the melted metal at the upper level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104. An inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops.

The ejector head 140 is movably mounted within Z-axis tracks for vertical movement of the ejector head with respect to the platform 112. One or more actuators 144 are operatively connected to the ejector head 140 to move the ejector head along a Z-axis and are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and an uppermost surface of an object on the platform 112.

Moving the platform 112 in the X-Y plane as drops of molten metal are ejected toward the platform 112 forms a swath of melted metal drops on the object being formed. Controller 148 also operates actuators 144 to adjust the vertical distance between the ejector head 140 and the most recently formed layer on the substrate to facilitate formation of other structures on the object. While the molten metal 3D object printer 100 is depicted in FIG. 1 as being operated in a vertical orientation, other alternative orientations can be employed. Also, while the embodiment shown in FIG. 1 has a platform that moves in an X-Y plane and the ejector head moves along the Z axis, other arrangements are possible. For example, the actuators 144 can be configured to move the ejector head 140 in the X-Y plane and along the Z axis or they can be configured to move the platform 112 in both the X-Y plane and Z-axis.

A controller 148 operates the switches 152. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108 and from another electrical source 156 to coil 204 for generating Lorentz forces in the upper portion of the vessel 104. That is, electrical power source 156 includes a plurality of independent power sources that can be independently connected to components in the printer 100 through switches 152 being operated by the controller 80. Because the heater 160 generates a great deal of heat at high temperatures, the coils 164 and 204 are positioned within a chamber 168 formed by one (circular) or more walls (rectilinear shapes) of the ejector head 140. As used in this document, the term “chamber” means a volume contained within one or more walls in which a heater, coils, and a removable vessel of a 3D metal object printer are located. The removable vessel 104 and the heater 160 are located within this chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coils 164 and 204 and the fluid carries the absorbed heat through the exchanger 180, where the heat is removed by known methods. The cooled fluid is returned to the fluid source 172 for further use in maintaining the temperature of the coils in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148, the controller can access through a server or the like a remote database in which the digital data model is stored, or a computer-readable medium in which the digital data model is stored can be selectively coupled to the controller 148 for access. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, or other polygonal mesh or other intermediate representation, which can in turn be processed to generate machine instructions, such as g-code, for fabrication of the device by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and the uppermost layer of the object on the platform 112.

The controller 148 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148 from either a scanning system or an online or work station connection for processing and generation of the signals that operate the components of the printer 100 to form an object on the platform 112.

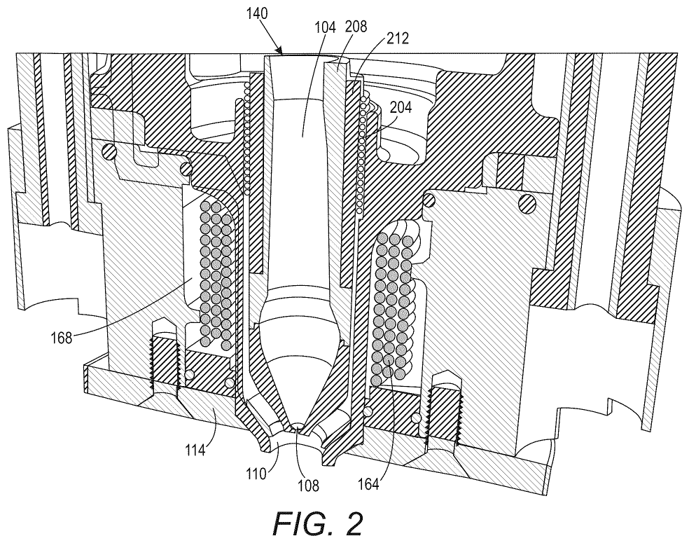

FIG. 2 is a cross-sectional view of the ejector head 140 and surrounding area taken along lines 2-2 in FIG. 1. The removable vessel 104 is positioned within a crucible 208 around which a heater 212 is located. The heater 212 is operatively connected to the controller 148 so the controller can operate the heater to heat the crucible and the vessel 104. The coil 204 has fewer turns than the coil 164 and is located at the upper end of the vessel 104 rather than the lower end as coil 164 is. The turns of the coil 204 are located between the inlet of the receptacle within vessel 104 and the middle of the receptacle in the vessel. The turns of the coil 204 extend over about one-third of the length of the vessel 104 between the inlet and the nozzle. The coil 204 by winding turns of uninsulated 20 gauge copper wire around the heater 212. The coil is operatively connected to electrical power 156 through a switch 152 so the controller 148 can selectively connect the coil 204 to the electrical power 156. The electrical power source 156 provides pulses of an alternating electrical current through the coil 204 to produce a traveling magnetic field in the melted metal held within the receptacle of vessel 104. A pulse provides the AC electrical current generated by an electrical power source for a predetermined period of time. In one embodiment, a pulse has a duration that provides at least one cycle of the AC electrical current, although longer durations can be used. In one embodiment, the electrical coil 204 has about twenty turns and the AC current is within a range of about 50 Hz to about 60 Hz at a potential of ±12 Volts and a current of about 240 ma to about 260 ma. The alternating current is pulsed through the coil at a rate of 0.1 Hz to 5 Hz to induce a traveling magnetic field of about 0.15 T to about 0.8 T in the melted metal. This traveling magnetic field produces Lorentz forces that move the melted metal both axially and radially. As used in this document, the term “traveling magnetic field” means a magnetic field produced by a pulse of electrical current through an electrical coil and the location of the magnetic field produced changes with each electrical current pulse. Thus, the Lorentz forces in the melted metal also change their positions in the metal. The traveling magnetic fields generated by the current pulses in the electrical coil produce Lorentz forces in the melted metal in the axial and radial directions within the upper portion of the vessel 104.

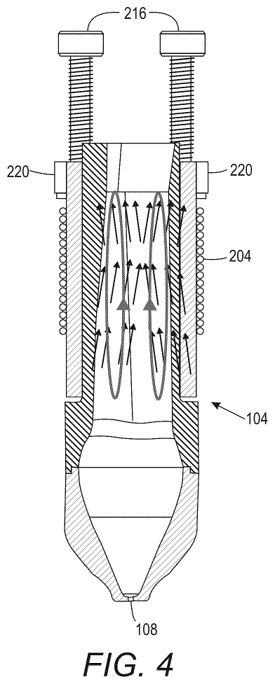

The Lorentz forces produced by traveling magnetic fields, which are indicated by the arrows in FIG. 4, circulate the melted metal in the upper portion of the vessel 104, which keeps any dross in the melted metal from accumulating at the surface of the melted metal within the receptacle. The controller 148 operates one of the switches 152 to provide pulses of alternating electrical current to the coil 204. In one embodiment, the controller 148 is configured to either operate one of the switches 152 on a periodic timed basis to provide the electrical current pulse to the coil 204. As used in this document, the term “periodic timed basis” means an event occurs at the expiration of each predetermined time interval in a series of predetermined time intervals having the same length. Alternatively, the controller is configured to operate the switch in response to the controller detecting that the reflected light intensity indicated by the signal generated by the level-sensor is below a predetermined intensity threshold that corresponds to an intensity level that indicates dross is beginning to interfere with light reflection. The direction of the electrical current can also be reversed by the controller operating another electrical switch 152 that changes the polarity of the electrical current received from the electrical power source to change the direction of the Lorentz forces in the melted metal at the upper end of the receptacle. This type of electrical coil operation further varies the Lorentz forces at work in the melted metal.

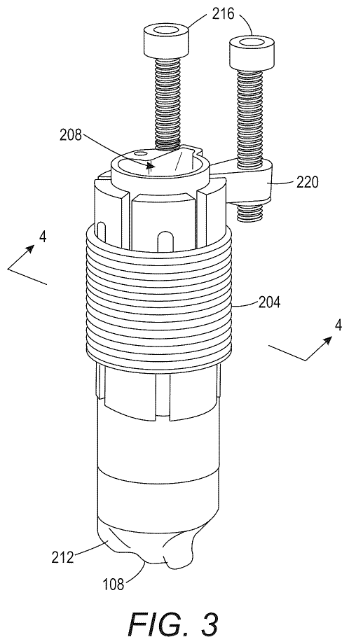

A perspective view of the vessel 104 with the coil 204 positioned about the vessel is presented in FIG. 3. The coil covers about the upper third of the vessel 104 and is positioned between the middle of the vessel and the inlet 208 to the receptacle of the vessel. Protrusions 212 are provided in the circumference of the vessel 104 near the nozzle 108 to aid in the positioning of the vessel when it is installed into the printer 100. Bolts 216 are received within threaded holes in collars 220 to secure the vessel in the printer once it is installed.

An alternative embodiment of the vessel 104 configured to stir the melted metal within the receptacle of the vessel is shown in FIG. 5. Using like reference numbers for like elements, the extruder 140 includes a vessel 104′ around which a plurality of coils 204A, 204B, 204C, 204D, and 204E are wrapped. Each coil is independently connected to a switch 152 so controller 148 can independently and selectively operate the corresponding switches to connect the corresponding coil to an AC electrical current source. The AC electrical current sources have the same current frequency range and current ampere range as current connected to coil 204 noted above with the embodiment shown in FIG. 1. The controller 80 is configured with programmed instructions that when executed cause the controller 80 to operate the switches 152 to which the coils 204A, 204B, 204C, 204D, and 204E are connected so the AC currents passed through each coil are out-of-phase with the electrical currents passing through the other coils. The degree to which the coils are out-of-phase with each other is in the range of 10 to 90 degrees. Thus, each coil induces a traveling magnetic field in the melted metal that has field lines that stir the melted metal differently than the fields induced by the other coils. These differing traveling magnetic fields stir the melted metal more intensely and further aid in the conditions that interfere with the formation of dross at the surface of the melted metal in the receptacle of the vessel 104′. FIG. 6 shows the vessel 104′ of FIG. 5 in a cross-sectional view while FIG. 7 shows the vessel 104 installed within a melted metal printer, such as the printer 100 of FIG. 1, in a cross-sectional view.

In operation, a vessel 104 with the single coil 204 or a vessel 104′ with a plurality of coils as shown in FIG. 5 through FIG. 7 wound around its upper third is installed in the printer 100 and the start-up procedure for the printer is performed. During metal object formation, the controller 148 either continuously or on a selective basis operates an electrical switch 152 to connect the coil 204 to an AC electrical current to produce traveling magnetic fields in the melted metal of the receptacle or to operate multiple switches to connect the multiple coils to out-of-phase AC electrical currents to produce differing traveling magnetic fields in the melted metal. This switch operation to produce traveling magnetic fields in the melted metal keeps dross from accumulating at the surface of the melted metal so the laser level-sensor can accurately measure the top level of the melted metal in the receptacle of the vessel 104 or 104′. This melted metal level monitoring enables solid metal to be fed into the inlet of the receptacle at appropriate times and in appropriate amounts to ensure the melted metal level in the receptacle remains within its upper and lower level bounds.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A metal drop ejecting apparatus comprising:
an ejector head having a vessel that defines a receptacle and a heater configured to heat the vessel so melted metal within the receptacle remains molten, the vessel having a first end and a second end and the receptacle having an inlet at the first end of the vessel and the receptacle having a nozzle at the second end of the vessel; and
at least one electrical coil wrapped around a portion of the vessel at a position closer to the inlet of the receptacle than to the nozzle of the receptacle, the at least one electrical coil being configured to produce at least one traveling magnetic field within the melted metal in the receptacle near the inlet.

2. The metal drop ejecting apparatus of claim 1 wherein the vessel is configured for installation into and removal from the ejector head.

3. The metal drop ejecting apparatus of claim 1 further comprising:
at least one electrical power source;
at least one electrical switch configured to connect each electrical coil of the at least one electrical coil to one electrical power source in the at least one electrical power source selectively; and
a controller operatively connected to the at least one electrical switch, the controller being configured to operate the at least one electrical switch selectively to connect each electrical coil of the at least one electrical coil to the at least one electrical power source selectively to produce the at least one traveling magnetic field within the melted metal in the receptacle near the inlet.

4. The metal drop ejecting apparatus of claim 3 wherein each electrical power source in the at least one electrical power source provides an AC electrical current in a range of about 240 ma to about 260 ma having a frequency in a range of about 50 Hz to about 60 Hz.

5. The metal drop ejecting apparatus of claim 3 wherein each electrical power source in the at least one electrical power source provides the AC electrical current with an electrical potential in the range of ±12 volts.

6. The metal drop ejecting apparatus of claim 3 wherein the at least one electrical coil is a plurality of electrical coils, the at least one electrical power source is a plurality of electrical power sources, and the at least one electrical switch is a plurality of electrical switches, each coil is connected to a different electrical power source in the plurality of power sources through different electrical switches in the plurality of electric switches in a one-to-one-to-one correspondence; and
the controller is further configured to operate the different electrical switches to connect the electrical coils in the plurality of electrical coils to the different electrical power sources independently and selectively.

7. The metal drop ejecting apparatus of claim 6, the controller being configured to operate the different electrical switches to connect the different electrical power sources to the electrical coils to pass the AC electrical current in each electrical coil that is out-of-phase with the AC electrical current in the other electrical coils.

8. The metal drop ejecting apparatus of claim 3 wherein the controller is configured to operate the at least one electrical switch on a periodic timed basis.

9. The metal drop ejecting apparatus of claim 3 further comprising:
an actuator configured to move solid metal into the inlet of the receptacle;
a level-sensor configured to generate a signal indicating a distance between the level-sensor and a surface of the melted metal in the receptacle; and
the controller being operatively connected to the actuator and the level-sensor, the controller further configured to operate the actuator to move solid metal into the inlet of the receptacle in response to the signal generated by the level-sensor indicating the distance is at a predetermined distance.

10. The metal drop ejecting apparatus of claim 9, the level-sensor further comprising:
a light generator and a sensor, the light generator being configured to direct light into a portion of the receptacle at the first end of the vessel and the sensor is configured to detect the directed light reflected by melted metal in the portion of the receptacle at the first end of the vessel and generate the signal indicating the distance between the sensor and the melted metal that reflected the directed light.

11. The metal drop ejecting apparatus of claim 10 wherein the sensor of the level-sensor is further configured to generate a signal indicative of an intensity of the reflected light detected by the sensor.

12. The metal drop ejecting apparatus of claim 11 wherein the controller is further configured to operate the at least one electrical switch in response to the generated signal indicative of the intensity of the reflected light being less than a predetermined intensity threshold.

13. The metal drop ejecting apparatus of claim 12 wherein the light generator is a laser.

14. The metal drop ejecting apparatus of claim 13 wherein the laser is a blue laser having a wavelength in a range of 400 nm to 500 nm.

15. The metal drop ejecting apparatus of claim 3 further comprising:
the controller being further configured to operate the at least one electrical switch to reverse the AC electrical current through the at least one coil to change a direction of the traveling magnetic field produced by the at least one coil in the melted metal within the receptacle.

16. The metal drop ejecting apparatus of claim 3 further comprising:
another electrical coil wrapped about the vessel at a position between the at least one electrical coil and the nozzle of the receptacle, the other electrical coil being configured to generate Lorentz forces in the melted metal near the nozzle of the receptacle that eject a drop of melted metal from the nozzle of the receptacle.

17. A vessel for holding melted metal within an ejector head of a metal drop ejecting apparatus comprising:
a wall defining a receptacle within the vessel, the receptacle having an inlet at a first end of the vessel and a nozzle at a second end of the vessel;
a heater configured to heat the vessel so melted metal within the receptacle remains molten; and
at least one electrical coil wrapped around a portion of the vessel at a position closer to the inlet of the receptacle than to the nozzle of the receptacle, the at least one electrical coil being configured to produce at least one traveling magnetic field within the melted metal in the receptacle near the inlet.

18. The vessel of claim 17, each electrical coil of the at least one electrical coil further comprising:
an electrical conductor having a plurality of turns around the vessel.

19. The vessel of claim 18 wherein the electrical conductor is an uninsulated copper wire.

20. The vessel of claim 19 wherein the copper wire is a 20 gauge copper wire.
